(19) United States
(12) Patent Application Publication
(10) Pub. No.: US 2015/0300474 A1
(43) Pub. Date: Oct. 22, 2015

(54) RING GEAR MOUNTING STRUCTURE

(71) Applicants: Yuki KUROSAKI, Susono-shi (JP); Hiroyuki SHIOIRI, Numazu-shi (JP)

(72) Inventors: Yuki KUROSAKI, Susono-shi (JP); Hiroyuki SHIOIRI, Numazu-shi (JP)

(73) Assignee: TOYOTA JIDOSHA KABUSHIKI KAISHA, Toyota-shi, Aichi-ken (JP)

(21) Appl. No.: 14/647,013

(22) PCT Filed: Nov. 22, 2013
(86) PCT No.: PCT/IB2013/002612

§ 371 Date: May 22, 2015

(30) Foreign Application Priority Data
Nov. 27, 2012 (JP) 2012-258256

(51) Int. Cl. F16H 48/38; F16H 55/17

(52) U.S. Cl. CPC F16H 48/38; F16H 55/17; F16H 2048/385

(57) ABSTRACT

A ring gear mounting structure is configured such that a ring gear is fitted onto a supporting portion, and the ring gear abuts against a stopper portion that protrudes from on one end portion of the outer peripheral surface in a rotational axis direction of the ring gear. A groove is formed in a portion of the outer peripheral surface that is on the stopper portion side of the outer peripheral surface. A portion of the outer peripheral surface, which is on a side opposite the stopper portion across the groove, is a press-fitting surface that the ring gear is press-fitted onto and contacts. A predetermined gap is formed in a radial direction of the ring gear and the rotational axis direction of the ring gear.

### BACKGROUND OF THE INVENTION

1. Field of the Invention

The invention relates to a structure for mounting a ring gear that has an overall annular shape and in which teeth are formed on an outer peripheral side, to a predetermined location or member. More particularly, the invention relates to a structure for mounting a helical ring gear such as a differential ring gear by press-fitting the helical ring gear onto a cylindrical supporting portion of a differential case.

2. Description of Related Art

Many gears are structured by forming a spur gear or a helical gear on an outer peripheral portion of a disc that is integrally formed with a shaft, or on an outer peripheral portion of a disc that is fitted to a shaft. There is also a gear that is referred to as a ring gear, in which teeth are formed on an outer peripheral portion of a so-called base portion that has a ring shape, and in which this base portion is mounted to a predetermined case or rotating body. This type of ring gear is used as a final reduction gear (differential gear set) of a vehicle, for example, and is mounted to a differential case, and is configured to transmit power output from a transmission to the differential case.

As a structure for mounting a ring gear to a differential case, a structure has been employed in which a flange-shaped disc that protrudes in the radial direction of the differential case is formed on the differential case, while an annular disc portion that extends to the inner peripheral side of the ring gear is integrally formed on the ring gear. The disc and the disc portion are overlapped with each other and fixed together by a bolt that passes through them. This kind of structure enables the ring gear to be reliably mounted to the differential case. However, this not only requires the disc and the disc portion, but also the bolt as component parts, as well as requires the manufacturing work of forming a through-hole to pass the bolt through, and fastening the bolt and the like. Therefore, there is room for improvement regarding the simplification, reduction in weight, and manufacturability and the like of the overall structure.

In view of this, structures for mounting a ring gear to a predetermined location or component without using a bolt have been developed as related art. Examples of these structures are described in EP Patent Application No. 647789, International Publication No. WO 2011/145189, and International Publication No. WO 2011/145179. These structures will now be briefly described. The structure described in EP Patent Application No. 647789 is a structure in which a cylindrical portion is provided on one end portion in an axial direction of a differential case, and a ring gear is fitted onto an outer peripheral side of this cylindrical portion. Then a flange-shaped portion (referred to as a base portion in EP Patent Application No. 647789) that protrudes radially outward is formed on one end portion of this cylindrical portion. A concavo-convex portion is formed along the entire periphery of a portion (a corner portion connected to the cylindrical portion) of the base of this base portion. Also, an arc-shaped concave portion formed by grinding the base portion in the thickness direction thereof is formed on a portion of the base portion that is farther toward the outer peripheral side than the concavo-convex portion, on a surface facing the ring gear side. The arc-shaped concave portion is designed to alleviate the concentration of stress. Also, a cutout portion that meshes with the arc-shaped concave portion is formed on one edge portion on the inner peripheral side of the ring gear. Furthermore, a collar that is able to be bent radially outward is formed on the other end portion in an axial direction of the cylindrical portion. The cutout portion that meshes with the collar is formed on the other end portion on the inner peripheral side of the ring gear. With the mounting structure described in EP Patent Application No. 647789 that has this kind of structure, the ring gear is fitted onto the cylindrical portion from the end portion side where the collar is formed. Then the concavo-convex portion and the cutout portion formed on the portion of the base of the base portion are placed in mesh with each other. Also, the collar is bent radially outward and placed in mesh with the cutout portion formed on the other end portion of the ring gear. Therefore, with the structure described in EP Patent Application No. 647789, torque is able to be transmitted by the meshing portion of the concavo-convex portion and the cutout portion that are in mesh with each other.

Also, the structure described in International Publication No. WO 2011/145189 is a structure in which a ring gear is fitted onto an outer peripheral surface of a portion that forms a cylindrical shape or a circular columnar shape. A first crimping portion that protrudes in the axial direction and is able to be bent radially outward is formed on one end portion in an axial direction of an outer peripheral surface of the portion that forms the cylindrical shape or the circular columnar shape, and a second crimping portion that protrudes radially outward and is able to be bent toward the outer peripheral surface side is formed on the other end portion. On the other hand, a notch is formed in the ring gear, in a position corresponding to the first crimping portion, and a circumferential groove is formed in a side surface of the ring gear that corresponds to the second crimping portion. With the structure described in International Publication No. WO 2011/145189, the ring gear is press-fitted onto the outer peripheral surface of the portion that forms the cylindrical shape or the circular columnar shape, and in this press-fitted state, the first crimping portion is bent radially outward so as to engage with the ring gear, and the second crimping portion is bent to the ring gear side so as to engage with the circumferential groove. As a result, with the structure described in International Publication No. WO 2011/145189, the contact pressure that is applied to the outer peripheral surface of the portion that forms the cylindrical shape or the circular columnar shape and the inner peripheral surface of the ring gear is even, so a reduction in contact pressure is able to be prevented.

Moreover, the structure described in International Publication No. WO 2011/145179 is a structure in which a ring gear is fitted onto an outer peripheral surface of a cylindrical or circular columnar-shaped portion, similar to the structure described in International Publication No. WO 2011/145189. A flange-shaped stopper portion that protrudes radially outward is formed on one end portion in the axial direction of an outer peripheral surface of a cylindrical or circular columnar-shaped portion. The stopper portion is formed so as to abut against the ring gear. Also, a crimping portion is formed on the other end portion in the axial direction of the outer peripheral surface. The crimping portion protrudes in the axial direction and is able to be bent radially outward. The ring gear is slid in the axial direction and press-fit onto the outside of the outer peripheral surface, and abutted against the stopper portion. Then, with the ring gear in a state abutted against the stopper portion, the crimping portion is bent radially outward. As a result, the crimping portion grips the ring gear. Also, with the structure described in International Publication No. WO 2011/145179, a circumferential groove in the circumferential direction is formed in substantially the center portion of the inner peripheral surface of the ring gear. Therefore, with the structure described in International Publication No. WO 2011/145179, stress from the ring gear clamping the outer peripheral surface is dispersed, so a localized increase in contact pressure is able to be reduced or alleviated.

The structures described in EP Patent Application No. 647789, International Publication No. WO 2011/145189, and International Publication No. WO 2011/145179 are structures in which a ring gear is fitted onto a cylindrical or circular columnar-shaped portion. Therefore, there is a portion that positions the ring gear in the axial direction and receives a thrust load. This portion is the portion referred to as the base portion in the structure in EP Patent Application No. 647789, is the second crimping portion in the structure described in International Publication No. WO 2011/145189, and is the stopper portion in the structure described in International Publication No. WO 2011/145179. When the ring gear is formed by a helical gear, a radial load and a thrust load that accompanies the transmission of torque are generated, so bending stress is generated in the portion that abuts against the ring gear in the axial direction (hereinafter this portion will tentatively be referred to as a “stopper portion”). With the structures described in International Publication No. WO 2011/145189 and International Publication No. WO 2011/145179, the portion that corresponds to this stopper portion extends radially outward, vertically from an outer peripheral surface onto which the ring gear is press-fitted (hereinafter this outer peripheral surface will tentatively be referred to as a “press-fitting surface”), such that this corner portion is a right angle. Therefore, stress concentrates at this corner portion, so there is room for improvement regarding durability.

Also, with the structure described in EP Patent Application No. 647789, the portion of the base of the stopper portion is recessed in a sectional arc shape, so the concentration of stress at this portion is able to be reduced or alleviated. However, the portion where the bending moment is large is thinner than the other portion, so the strength of the stopper portion may be insufficient. If the stopper portion is made thicker so that it will be sufficiently strong, the entire structure will become larger or heavier.

### SUMMARY OF THE INVENTION

The invention thus provides a mounting structure that is capable of alleviating the concentration of stress at a so-called stopper portion that abuts against a ring gear and receives a thrust load, and is also capable of inhibiting or mitigating an increase in localized contact pressure or stress from press-fitting the ring gear on.

A first aspect of the invention relates to a ring gear mounting structure configured such that a ring gear is fitted onto an outer peripheral side of a supporting portion of which an outer peripheral surface is formed in a circular shape, and the ring gear abuts against a stopper portion formed protruding radially outward from the outer peripheral surface on one end portion of the outer peripheral surface in a rotational axis direction of the ring gear. A groove is formed in a portion of the outer peripheral surface that is on the stopper portion side of the outer peripheral surface; a portion of the outer peripheral surface, which is on a side opposite the stopper portion across the groove, is a press-fitting surface that the ring gear is press-fitted onto and contacts; and predetermined gap is formed in a radial direction of the ring gear, between an inner peripheral surface of the ring gear, and a boundary portion of the groove and the press-fitting surface.

In the ring gear mounting structure according to the first aspect of the invention, the predetermined gap may be formed in a radial direction of the ring gear and the rotational axis direction of the ring gear, between an inner peripheral surface of the ring gear, and a boundary portion of the groove and the press-fitting surface.

In the ring gear mounting structure according to the first aspect of the invention, a thrust load may be applied to the stopper portion by the ring gear against which the stopper portion abuts.

In the ring gear mounting structure according to the first aspect of the invention, the groove may be formed in a shape in which a cross-section of a bottom portion of the groove along the rotational axis direction of the ring gear forms an arc, and a straight line along a side surface of the stopper portion that abuts against the ring gear may coincide with a tangent to the arc.

In the ring gear mounting structure according to the first aspect of the invention, the groove and the press-fitting surface may be connected by a connecting surface of which a cross-section of the groove and the press-fitting surface are along the rotational axis direction of the ring gear forms an arc-shape, and a center portion in a width direction of the connecting surface may be the boundary portion.

In the ring gear mounting structure according to the first aspect of the invention, the supporting portion may be made of metal material that has not undergone quenching treatment. Also, at least the groove, the press-fitting surface, and the surface of the stopper portion that abuts against the ring gear may be formed by continuous cutting or grinding.

In the ring gear mounting structure according to the first aspect of the invention, a tapered surface that will become a guide surface when fitting the ring gear onto the supporting portion may be formed on an end portion of the inner peripheral surface of the ring gear, which abuts against the stopper portion. Also, a width of the tapered surface in the rotational axis direction of the ring gear may be set wider than a distance between the boundary portion and the side surface of the stopper portion the side surface abutting against the ring gear, and the predetermined gap may be formed between the ring gear and the boundary portion.

In the ring gear mounting structure according to the first aspect of the invention, a wide diameter portion having an inner diameter larger than an outer diameter of the press-fitting surface and a width wider than a distance between the boundary portion and the side surface of the stopper portion, the side surface abutting against the ring gear, may be formed on an end portion side of the inner peripheral surface of the ring gear, which abuts against the stopper portion.

In the ring gear mounting structure according to the first aspect of the invention, the ring gear may include a helical gear.

A second aspect of the invention relates to a ring gear mounting structure configured such that a ring gear is fitted onto an outer peripheral side of a supporting portion of which an outer peripheral surface is formed in a circular shape, and the ring gear abuts against a stopper portion formed protruding radially outward from the outer peripheral surface on one end portion of the outer peripheral surface in a rotational axis direction of the ring gear, such that a thrust load of the ring gear acts on the stopper portion. A groove is formed in a portion of the outer peripheral surface that is on the stopper portion side of the outer peripheral surface. A portion of the outer peripheral surface, which is on a side opposite the stopper portion across the groove, is a press-fitting surface that the ring gear is press-fitted onto and contacts. The groove and the press-fitting surface are connected by an arced surface of which a cross-section of the groove and the press-fitting surface are along the rotational axis direction of the ring gear forms an arc shape, and a predetermined gap is formed between the arced surface and an inner peripheral surface of the ring gear.

In the ring gear mounting structure according to the second aspect of the invention, the groove may be formed in a shape in which a cross-section of a bottom portion of the groove along the rotational axis direction of the ring gear forms an arc. Also, a straight line along a side surface of the stopper portion, which abuts against the ring gear, may coincide with a tangent to the arc.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a partial enlarged sectional view of the structure around a clearance groove, illustrating one example of the invention;

FIG. 2 is a partial enlarged sectional view of the structure around a clearance groove, illustrating another example of the invention;

FIG. 3 is a partial enlarged sectional view of the structure around a clearance groove, illustrating yet another example of the invention; and

FIG. 4 is a partial sectional view of one example of a differential gear set to which the invention may be applied.

### DETAILED DESCRIPTION OF EMBODIMENTS

The example embodiment of the invention is a structure for mounting a ring gear to a predetermined supporting portion. This ring gear is a conventionally known annular gear with teeth formed on an outer peripheral surface. The ring gear may be a spur gear, but the effect of the invention will be greater if it is a helical gear. The supporting portion to which the ring gear is mounted, i.e., the outer peripheral surface that the ring gear fits onto, is a circular-shaped portion. Therefore, the supporting portion may be a portion that forms a cylindrical shape, or a circular columnar shape. Furthermore, the example embodiment of the invention may be applied to a ring gear arranged such that a rotation center axis of the ring gear is parallel to a rotation center axis of a predetermined driving side gear. This example is a ring gear of a differential gear set that forms part of a transaxle for a vehicle. Therefore, the detailed example described below is an example in which a ring gear of such a differential gear set is mounted to a supporting portion of a differential case.

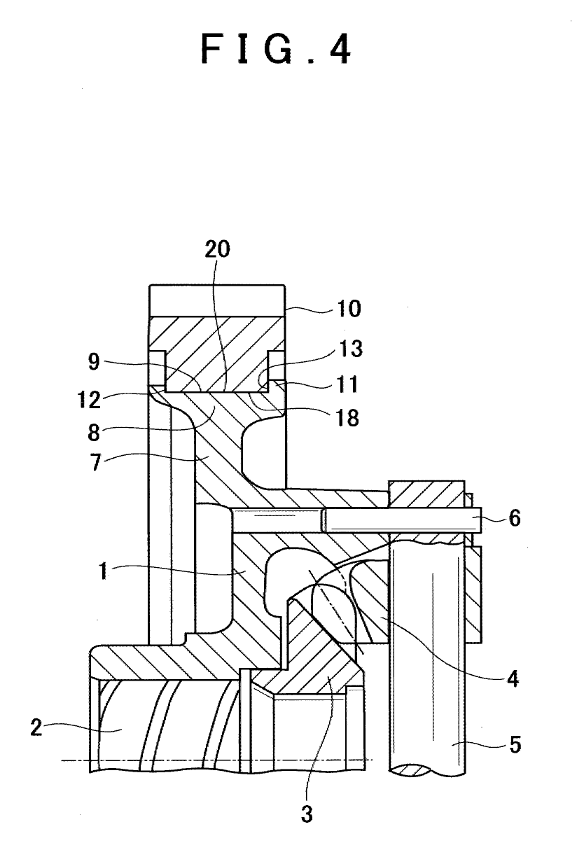

FIG. 4 is a partial sectional view of one example of a differential gear set to which the invention may be applied. A through-hole 2 that a rotating shaft, not shown, is inserted into is formed in a center portion of a differential case 1. A central axis of a side gear 3 coincides with a central axis of this through-hole 2. The side gear 3 is rotatably housed inside the differential case 1. The side gear 3 is a bevel gear. A pinion gear 4 rotates and revolves in mesh with the side gear 3. The pinion gear 4 is rotatably supported by a pinion pin 5. The pinion pin 5 is attached to the differential case 1 by a pin 6.

A disc portion 7 that protrudes in a vertical direction with respect to the central axis of the through-hole 2 is integrally formed with the differential case 1, on an outside portion of the differential case 1. A cylindrical supporting portion 8 that is centered around the central axis of the through-hole 2 is formed on an outer peripheral end of the disc portion 7. An outer peripheral surface 9 of this supporting portion 8 is formed in a circular shape, and a ring gear 10 is mounted by being fitted onto the outer peripheral surface 9. More specifically, a stopper portion 11 is provided on one end portion (i.e., the right end portion in FIG. 4) of the supporting portion 8 in an axial direction thereof. This stopper portion 11 is a portion that abuts against the ring gear 10 in the axial direction, thereby positioning the ring gear 10 and receiving a thrust load. The stopper portion 11 is formed protruding radially outward from one end portion of the outer peripheral surface 9. Also, a crimping portion 12 is integrally formed with the supporting portion 8 on an end portion of the supporting portion 8 that is on a side opposite the stopper portion 11. The crimping portion 12 is a relatively thin flange-shaped portion formed protruding in the axial direction from the outer peripheral surface 9, and is designed to be bent (i.e., crimped) radially outward. A concavo-convex portion, not shown, that includes elongated grooves recessed in the axial direction may be provided along the entire periphery. According to this kind of structure, by bending the crimping portion 12 radially outward, part of the ring gear 10 is able to be made to plastic deform by the convex portion of the concavo-convex portion, such that this convex portion grips the ring gear 10, while part of the ring gear 10 is able to be made to grip the concave portion of the concavo-convex portion.

The ring gear 10 is a helical gear, and is mounted by being press-fitted onto the outer peripheral surface of the supporting portion 8. With the ring gear 10 press-fit onto the outer peripheral surface of the supporting portion 8, one end portion of the ring gear 10 in the axial direction abuts against a side surface 13 of the stopper portion 11. Also, the crimping portion 12 is bent radially outward and bites into the edge portion on the inner peripheral side of the ring gear 10.

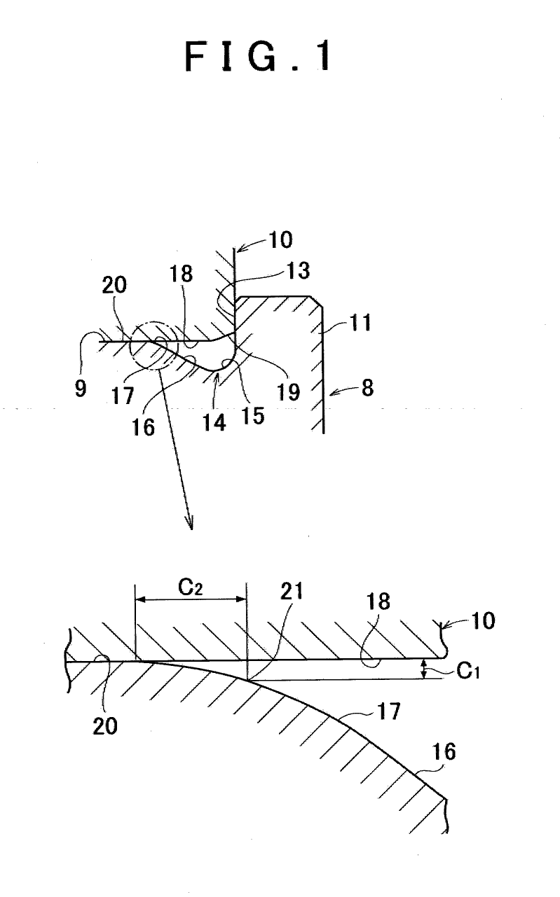

FIG. 1 is a partial enlarged sectional view of a characteristic structure of the example embodiment of the invention, and shows an area of the supporting portion 8 near the stopper portion 11. A portion of the outer peripheral surface 9 on the stopper portion 11 side is a clearance groove 14 that is recessed toward the inner peripheral side in the radial direction, and corresponds to a groove of the invention. This clearance groove 14 is designed to ensure the area of the stopper portion 11 that abuts against the ring gear 10, and simultaneously alleviate the concentration of stress. That is, a portion on the stopper side of the outer peripheral surface of the supporting portion that fits together with the ring gear forms a groove by being recessed toward the inner peripheral side in the radial direction, so the concentration of stress at the so-called base portion of the stopper portion is able to be prevented or alleviated. Also, the side surface of the stopper portion that abuts against the ring gear extends farther to the inner peripheral side than a position corresponding to an outer diameter of a press-fitting surface, so the area that abuts against the ring gear is able to be sufficiently ensured. The clearance groove 14 is formed by cutting or grinding the outer peripheral surface 9 of the supporting portion 8 toward the inside in the radial direction, along the side surface 13 of the stopper portion 11. The shape of the clearance groove 14 is such that a cross-section thereof, when a bottom portion 15 that is the most recessed (i.e., the deepest) is cut along the axial direction from the outer peripheral surface 9, has a recessed arc-shape, and a straight line extending in the radial direction along the side surface 13 coincides with a tangent to this recessed arc. Therefore, the stopper portion 11 does not have a portion that is cut into in the thickness direction in the entire area from a portion of the base of the stopper portion 11 to a tip end portion on the outer peripheral side (i.e., an outer peripheral end portion), so there is no thin portion at least on the base side of the stopper portion 11. That is, the thickness of the stopper portion is not reduced, so the strength of the stopper portion can be increased in addition to alleviating the concentration of stress. Therefore, the durability of a mounting structure in which the ring gear is fitted onto the supporting portion is able to be improved.

Also, a portion where the outer diameter increases from the bottom portion 15 of the clearance groove 14 toward the outer peripheral surface 9 is an inclined surface 16 with a relatively small inclination angle (taper angle) with respect to the central axis of the supporting portion 8. In the example shown in FIG. 1, this inclined surface 16 is a tapered surface. Therefore, the inclined surface 16 is a surface of which a cross-section when the inclined surface 16 is cut along the axial direction of the supporting portion 8 appears as a straight line as shown in FIG. 1. This inclined surface 16 is not directly continuous with the outer peripheral surface 9, but instead is continuous via an arc-shaped connecting surface 17. In other words, the arc-shaped connecting surface 17 is interposed between the inclined surface 16 and the outer peripheral surface 9. This connecting surface 17 is a surface of which a cross-section when the connecting surface 17 is cut on a plane along the axial direction of the supporting portion 8 or the rotational axis direction of the ring gear 10 forms an arc shape as shown in FIG. 1. The connecting surface 17 is smoothly connected to both the inclined surface 16 and the outer peripheral surface 9. That is, a tangent to an end portion on the inclined surface 16 side of the connecting surface 17 coincides, or substantially coincides, with a tangent to the inclined surface 16 at the end portion on the inclined surface 16 side of the connecting surface 17. Similarly, a tangent to an end portion on the outer peripheral surface 9 side of the connecting surface 17 coincides, or substantially coincides, with a tangent to the outer peripheral surface 9 at the end portion on the outer peripheral surface 9 side of the connecting surface 17. In other words, the outer peripheral surface 9 and the connecting surface 17 are connected together smoothly without any corners.

The ring gear 10 is press-fitted onto the outer peripheral surface 9 that the clearance groove 14 is formed in. A press-fitting allowance thereof is set such that the contact pressure between the supporting portion 8 and the ring gear 10 is high so sufficiently large torque is transmitted by friction force between the supporting portion 8 and the ring gear 10. The press-fitting allowance is a dimensional difference between the radius of the inner peripheral surface of the ring gear 10 and the radius of the outer peripheral surface 9 of the supporting portion 8 when they are not fitted together, and is the dimensional difference when the radius of the inner peripheral surface of the ring gear 10 is smaller than the radius of the outer peripheral surface 9 of the supporting portion 8. An inner peripheral surface 18 of the ring gear 10 has a tapered guide surface 19 formed on the stopper portion 11 side, i.e., on a tip end side when fitted to the supporting portion 8. This guide surface 19 is a tapered surface that guides the ring gear when fitting the ring gear onto the supporting portion. Also, the inner peripheral surface 18 of the ring gear 10 is such that a surface farther toward a rear end side than the guide surface 19 is a cylindrical surface. The inner peripheral surface 18 contacts the outer peripheral surface of the supporting portion 8 at a portion of this cylindrical surface. In other words, the inner peripheral surface 18 of the ring gear 10 is such that the majority of a portion corresponding to the connecting surface 17 and a portion corresponding to the clearance groove 14 do not contact the supporting portion 8 or the outer peripheral surface 9 thereof.

Therefore, of the outer peripheral surface 9 of the supporting portion 8, a portion that contacts the inner peripheral surface of the ring gear 10 and is squeezed by the ring gear 10 is a press-fitting surface 20. The arc-shaped connecting surface 17 described above connects this press-fitting surface 20 with the inclined surface 16 of the clearance groove 14. In this example embodiment of the invention, a center portion in the width direction of the connecting surface 17 that forms an arc shape becomes a boundary portion 21 of the clearance groove 14 and the outer peripheral surface 9. This boundary portion 21 is shown as a point in FIG. 1, but is not limited to this. That is, the boundary portion 21 may also be a region having a predetermined width in a middle portion of the boundary portion 21 that forms an arc shape. Also, a predetermined gap C1 in the radial direction and a predetermined gap C2 in the axial direction are open between this boundary portion 21 and the inner peripheral surface 18 of the ring gear 10. In particular, the gap C1 in the radial direction gradually widens from an end portion on the press-fitting surface 20 side toward the inclined surface 16 side. This is because the press-fitting surface 20 and the inclined surface 16 are connected by a smooth surface with no corners.

In the mounting structure according to this example embodiment of the invention, press-fitting the ring gear 10 onto the outer peripheral surface 9 of the supporting portion 8 results in large contact pressure being applied between the two, which in turn increases the friction force between the two. Also, the ring gear 10 abuts against the side surface 13 of the stopper portion 11, such that friction force is generated between the two. By forming the clearance groove 14, the side surface 13 of the stopper portion 11 also extends farther to the inner peripheral side than a position with the same outer diameter as the press-fitting surface 20 described above. Therefore, the surface that is able to abut against the ring gear 10 is able to be ensured to the greatest extent possible on the inner peripheral side of the supporting portion 8. In other words, nothing causes the area of the surface that abuts against the ring gear 10 to be reduced. As a result, both the strength of the stopper portion 11 and the area of the surface that transmits torque increase. Furthermore, as described above, the crimping portion 12 is engaged by biting into the ring gear 10, so torque is transmitted between the ring gear 10 and the supporting portion 8 by this biting portion as well.

When the ring gear 10 is a helical gear as described above, a mating gear, not shown, is in mesh with the ring gear 10, and as this mating gear rotates, it transmits torque. As a result, a load in the radial direction and a load in the thrust direction act on the ring gear 10. The thrust load acts on the stopper portion 11 that is abutting against the ring gear 10, and acts to increase the contact pressure between the two. In this case, a bending moment is applied to the stopper portion 11, but because the arc-shaped clearance groove 14 is formed on a portion of the so-called base of the stopper portion 11, the concentration of stress is alleviated, so sufficient strength and durability are able to be maintained. Also, the clearance groove 14 is not recessed toward the stopper portion 11 side, so sufficient thickness of the stopper portion 11 is ensured. As a result, the stopper portion 11 has excellent strength and durability.

On the other hand, while large contact pressure is generated on the press-fitting surface 20 of the supporting portion 8, on the clearance groove 14 side, the supporting portion 8 does not contact the inner peripheral surface of the ring gear 10, so stress tends to increase locally at the portion of the press-fitting surface 20 on the clearance groove 14 side. However, with the mounting structure according to this example embodiment of the invention, the boundary portion 21 indicated by a point between the press-fitting surface 20 and the clearance groove 14, or by a region of a predetermined width is provided. That is, a boundary portion of the groove and the press-fitting surface is created by forming a groove by recessing the outer peripheral surface of the supporting portion, and a gap is provided between this boundary portion and the inner peripheral surface of the ring gear. More specifically, a gap is provided between the boundary portion and the inner peripheral surface of the ring gear in both the radial direction and the axial direction, so the inner peripheral surface of the ring gear will not contact the boundary portion. Therefore, even if the structure is such that an arc-shaped connecting surface is interposed between the groove and the press-fitting surface, and a center portion in the width direction of this connecting surface is made the boundary portion, so-called clamping force caused by press-fitting the ring gear will not be directly applied to this boundary portion. Accordingly, stress generated in the supporting portion, and in particular, a peak value of this stress, is able to be reduced. Therefore, according to the invention, deformation of the press-fitting surface and a decrease in contact pressure and the like are able to be prevented or inhibited, so the designed performance is able to be displayed and maintained. Also, not only does the inner peripheral surface of the ring gear 10 not contact the boundary portion 21, but the outer peripheral surface 9 of the supporting portion 8 gradually separates from the inner peripheral surface of the ring gear 10 by the arced surface. Therefore, deformation of the press-fitting surface and a decrease in contact pressure and the like are able to be prevented or inhibited, so the designed performance is able to be displayed and maintained. Also, the clamping force by the ring gear 10 is able to be dispersed. In other words, even if the outer diameter of the outer peripheral surface 9 that is constant at the press-fitting surface 20 decreases on the clearance groove 14 side, the surface is able to be a smooth surface with no corners by gradually reducing the outer diameter in a continuous manner instead of in steps. Therefore, it is possible to eliminate or mitigate stress generated in the supporting portion 8 from changing in steps, or eliminate or mitigate the concentration of stress on one side of a location where such a change in the stress occurs. As a result, it is possible to avoid or inhibit stress in the supporting portion 8 from exceeding a yield point when transmitting large torque, and thus avoid or inhibit plastic deformation due to the stress in the supporting portion 8 exceeding the yield point. Therefore, the contact pressure between the supporting portion 8 and the ring gear 10 that is press-fitted onto the supporting portion 8 is able to be kept at the designed value, and a differential gear set that transmits the designed torque is able to be obtained, or the durability of the differential gear set is able to be improved.

Here, the machining of the supporting portion 8 described above will be described. The differential case 1 is a casting made of iron. The differential case 1 has not undergone any special heat treatment or heat hardening treatment such as quenching treatment. Portions that other portions are mounted to, such as the outer peripheral surface 9 of the supporting portion 8, are cut or ground. Then of the portion on the outer peripheral side of the supporting portion 8, at least the side surface 13 and the clearance groove 14 of the stopper portion 11, the connecting surface 17, and the press-fitting surface 20 that continues on from the connecting surface 17, are finished by undergoing a series of continuous processes. That is, finishing is performed by continuously moving the machining tools and the supporting portion 8 that is the member to be machined relative to one another, and machining the entire region from the side surface 13 to the press-fitting surface 20 collectively. As a result, the connecting surface 17, the inclined surface 16 that is connected to the connecting surface 17, and the press-fitting surface 20 become a smooth continuous surface without any corners. Therefore, the peak of the stress generated in the supporting portion 8 is able to be more effectively reduced or alleviated.

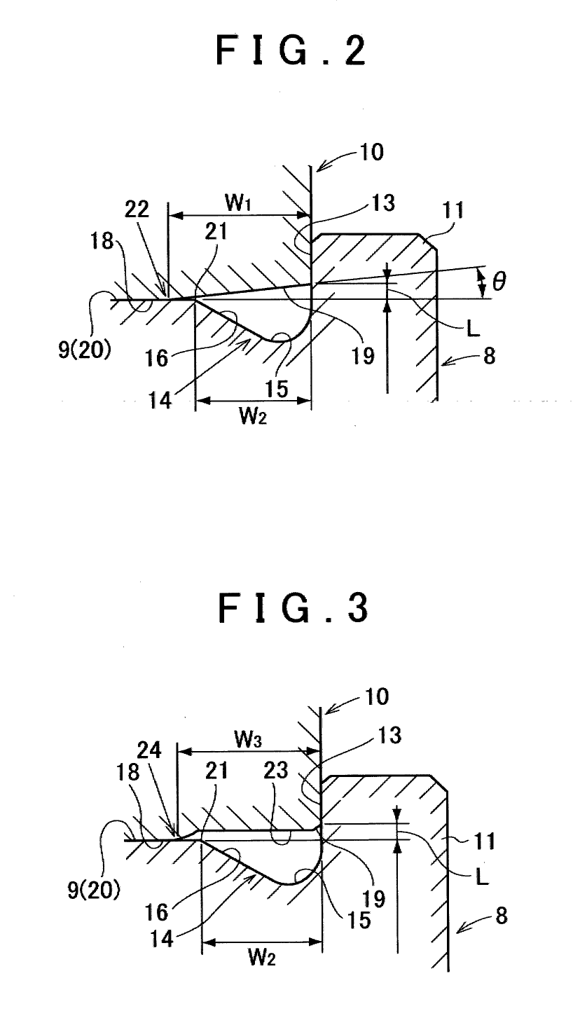

The main point of the mounting structure of the invention is to not have so-called clamping force be directly applied from the ring gear 10 to the boundary portion 21 of the clearance groove 14 and the press-fitting surface 20, by not having the inner peripheral surface of the ring gear 10 contact the boundary portion 21. This is also able to be achieved by a structure other than the structure shown in FIG. 1 described above. FIG. 2 shows just such an example. In the example shown in FIG. 2, an inclination angle (the generating line angle of the tapered surface) 0 of the guide surface 19 formed on the tip end side of the ring gear 10 on the inner peripheral surface of the ring gear 10 is smaller than the angle of the detailed example described above. Accordingly, a width W1 of the guide surface 19 in the axial direction is larger than a width W2 of the clearance groove 14. Therefore, a starting end 22 of the guide surface 19 is in a position beyond the clearance groove 14 on the press-fitting surface 20 side, while an opening amount L of the guide surface 19 on the side surface of the ring gear 10 that abuts against the stopper portion 11 is the same as that of the ring gear 10 shown in FIG. 1 described above. This starting end 22 is chamfered so as to form an arc-shape so that there are no corners.

However, the boundary portion 21 of the clearance groove 14 and the press-fitting surface 20 in the example shown in FIG. 2 is not formed in an arc shape. Instead, the boundary portion 21 is a corner portion where the inclined surface 16 and the press-fitting surface 20 intersect at a predetermined angle. However, the dimension from the side surface 13 of the stopper portion 11 to this boundary portion 21, i.e., the width W2 of the clearance groove 14, is smaller than a width W1 of the tapered guide surface 19, so there is a predetermined gap between the ring gear 10 and the boundary portion 21 that is a corner portion. That is, so-called clamping force generated as the ring gear 10 is press-fitted onto the outer peripheral surface 9 (i.e., the press-fitting surface 20) of the supporting portion 8 is not applied to the boundary portion 21.

Therefore, with the mounting structure shown in FIG. 2, a predetermined terminal end portion of the press-fitting surface 20 (i.e., a terminal end portion in the axial direction, i.e., the left/right direction in FIG. 2) where contact pressure is generated is in a position corresponding to the starting end 22 of the guide surface 19, or is near a position corresponding to the starting end 22, and is in a position farther toward the center of the press-fitting surface 20 than the boundary portion 21. Contact pressure is generated as the ring gear 10 is press-fitted on. Thus, a location where there is contact pressure and a location where there is no contact pressure are locations on the press-fitting surface 20 that are continuous at a constant outer diameter in a cylindrical shape or a circular columnar shape. The contact pressure is the so-called clamping force from the ring gear 10. Therefore, it is possible to avoid or inhibit the stress in the supporting portion 8 from changing in a stepped manner according to the position of the press-fitting surface 20 in the axial direction, as well as avoid or inhibit stress from increasing locally due to a stepped change in the stress. As a result, the same effects as those obtained with a structure such as that shown in FIG. 1 described above are also able to be obtained with a structure such as that shown in FIG. 2.

Also, an example shown in FIG. 3 is an example in which a large diameter portion 23 is formed on a tip end side of the inner peripheral surface of the ring gear 10, which abuts against the stopper portion 11. This large diameter portion 23 is a cylindrical portion with an inner diameter that is larger than the outer diameter of the press-fitting surface 20 described above. This large diameter portion 23 is chamfered on an open end on the stopper portion 11 side, and the tapered surface resulting from the chamfering serves as the guide surface 19. An opening amount L that is the sum of the opening amount of this guide surface 19 and the opening amount of the large diameter portion 23 is the same as the opening amount L of the guide surface 19 shown in FIGS. 1 and 2 described above. Therefore, the inner diameter of the large diameter portion 23 is smaller than the inner diameter of the open end of the guide surface 19 and larger than the outer diameter of the press-fitting surface 20. Also, a width W3 of the large diameter portion 23 in the axial direction is larger than a width W2 of the clearance groove 14 in the axial direction, and a starting end 24 of this large diameter portion 23 is positioned beyond the clearance groove 14 on the press-fitting surface 20 side. The starting end 24 is formed in an arc shape by being chamfered so that there are no corners. Also, the large diameter portion 23 is such that the surface between the starting end 24 and a cylindrical portion where the inner diameter is constant is a tapered surface. This taper angle may be set as appropriate, but is a small angle.

Therefore, with the mounting structure shown in FIG. 3, the terminal end portion of the press-fitting surface 20 located where contact pressure is generated (i.e., the terminal end portion in the axial direction that is the left/right direction in FIG. 3) is in a position corresponding to the starting end 24 of the large diameter portion 23, or is near a position corresponding to the starting end 24, and is in a position closer toward the center of the press-fitting surface 20 than the boundary portion 21. Contact pressure is generated as the ring gear 10 is press-fitted on. Therefore, a location where there is contact pressure and a location where there is no contact pressure are locations on the press-fitting surface 20 that are continuous at a constant outer diameter in a cylindrical shape or a circular columnar shape. The contact pressure is the so-called clamping force by the ring gear 10. Therefore, it is possible to avoid or inhibit stress in the supporting portion 8 from changing in a stepped manner according to the position of the press-fitting surface 20 in the axial direction, as well as avoid or inhibit stress from increasing locally due to a stepped change in the stress. As a result, the same effects as those obtained with a structure such as that shown in FIG. 1 described above are also able to be obtained with a structure such as that shown in FIG. 3.

1. A ring gear mounting structure comprising:
a supporting portion of which an outer peripheral surface has a circular shape;
a ring gear fitted onto an outer periphery of the supporting portion;
a stopper portion that protrudes radially outward from the outer peripheral surface on one end, in a rotational axis direction of the ring gear, of the outer peripheral surface, the stopper portion being to abut against the ring gear;
a groove recessed toward an inner peripheral side in a radial direction, in a first portion of the outer peripheral surface, the first portion being on a stopper portion side of the outer peripheral surface; and
a press-fitting surface that the ring gear is press-fitted onto and contacts, at a portion of the outer peripheral surface, the second portion being on a side opposite the stopper portion across the groove; wherein
a predetermined gap includes a first predetermined gap defined in a radial direction of the ring gear, between an inner peripheral surface of the ring gear and a boundary portion of the outer peripheral surface that is a boundary between the groove and the press-fitting surface, and
wherein the groove and the press-fitting surface are connected by a connecting surface, a cross-section, along the rotational axis direction of the ring gear, of the connecting surface is an arc-shape, and a center portion in a width direction of the connecting surface is the boundary portion.

2. The ring gear mounting structure according to claim 1,
wherein the predetermined gap further includes a second predetermined gap defined in the rotational axis direction of the ring gear.

3. The ring gear mounting structure according to claim 1, wherein a thrust load is applied to the stopper portion by the ring gear against which the stopper portion abuts.

4. The ring gear mounting structure according to claim 1, wherein the groove is formed in a shape in which a cross-section of a bottom portion of the groove along the rotational axis direction of the ring gear forms an arc; and a straight line along a side surface of the stopper portion that abuts against the ring gear coincides with a tangent to the arc.

5. (canceled)

6. The ring gear mounting structure according to claim 1, wherein the supporting portion is made of metal material that has not undergone quenching treatment, and
at least the groove, the press-fitting surface, and a side surface of the stopper portion that abuts against the ring gear are formed by continuous cutting or grinding.

7. The ring gear mounting structure according to claim 1, wherein an end portion of the inner peripheral surface of the ring gear has a tapered surface, the tapered surface is a guide surface to fit the ring gear onto the supporting portion, and the end portion abuts against the stopper portion,
a width of the tapered surface in the rotational axis direction of the ring gear is set wider than a distance between the boundary portion and the side surface of the stopper portion, the side surface abuts against the ring gear, and
the predetermined gap is defined between the ring gear and the boundary portion.

8. The ring gear mounting structure according to claim 1,
wherein a wide diameter portion is arranged on a side of an end portion of the inner peripheral surface of the ring gear, the end portion abuts against the stopper portion,
the wide diameter portion has an inner diameter larger than an outer diameter of the press-fitting surface and a width wider than a distance between the boundary portion and a side surface of the stopper portion, and the side surface abuts against the ring gear.

9. The ring gear mounting structure according to claim 1, wherein
the ring gear includes a helical gear.

10. A ring gear mounting structure comprising:
a ring gear;
a supporting portion of which an outer peripheral surface has a circular shape, the ring gear fitted to an outer peripheral side of the supporting portion;
a stopper portion that protrudes radially outward from the outer peripheral surface on one end, in a rotational axis direction of the ring gear, of the outer peripheral surface, the stopper portion being to abut against the ring gear, and a thrust load being applied to the stopper portion;
a groove recessed toward an inner peripheral side in a radial direction, in a first portion of the outer peripheral surface, the first portion being on a stopper portion side of the outer peripheral surface;
a press-fitting surface that the ring gear is press-fitted onto and contacts, at a second portion of the outer peripheral surface the second portion being on a side opposite the stopper portion across the groove; and
an arced surface a cross-section of which, along the rotational axis direction of the ring gear, being an arc-shape, the arced surface that connects the groove and the press-fitting surface, and a predetermined gap being defined between the arced surface and an inner peripheral surface of the ring gear.

11. The ring gear mounting structure according to claim 10,
wherein a cross-section, along the rotational axis direction of the ring gear, of a bottom portion of the groove is an arc-shape, and
a straight line along a side surface of the stopper portion coincides with a tangent to an arc, and the side surface abuts against the ring gear.
